(19) United States
(12) Patent Application Publication
(10) Pub. No.: US 2013/0259374 A1
(43) Pub. Date: Oct. 3, 2013

(54) IMAGE SEGMENTATION

(71) Applicants: Lulu He, Evanston, IL (US); Feng Tang, Mountain View, CA (US); Qian Lin, Santa Clara, CA (US)

(72) Inventors: Lulu He, Evanston, IL (US); Feng Tang, Mountain View, CA (US); Qian Lin, Santa Clara, CA (US)

(21) Appl. No.: 13/433,948

(22) Filed: Mar. 29, 2012

(51) Int. Cl. G06K 9/34

(52) U.S. Cl. 382/173

(57) ABSTRACT

In one implementation, an image segmentation system defines a first discriminative classifier and a second discriminative classifier. The first discriminative classifier is associated with a first segment of an object in an image based on a first foreground sample region of the image and a first background sample region of the image. The second discriminative classifier is associated with a second segment of the object based on a second foreground sample region of the image and a second background sample region of the image. The image segmentation system then identifies at least a portion of the first segment using the first discriminative classifier and at least a portion of the second segment using the second discriminative classifier.

### BACKGROUND

Image segmentation can be used to identify objects within images. For example, an image can be segmented to identify a particular object such as a person (or representation of a person) within the image. The representation of the person can then be copied or extracted from the image and added to another image.

Some image segmentation systems provide a user interface via which a user can provide input to identify a portion of an object within an image that should be segmented (or extracted from the image). Such image segmentation systems then sample the portion (or sample region) of the object, generate a model of the object using the identified portion of the object, and identify the object using the model.

### BRIEF DESCRIPTION OF THE DRAWINGS

FIG. 1 is a flowchart of an image segmentation process, according to an implementation.

FIG. 2 is a flowchart of an image segmentation process, according to another implementation.

FIG. 3 is a schematic block diagram of an image segmentation system, according to an implementation.

FIGS. 4A-4G illustrate image segmentation within an image segmentation system, according to an implementation.

FIG. 5 is a schematic block diagram of an image segmentation system hosted at a computing system, according to an implementation.

### DETAILED DESCRIPTION

Image segmentation systems that rely on a model of an object generated from a sample region can fail to accurately identify the object. For example, if the sample region includes not only a portion of the object, but also other portions of the image, the model can fail to accurately represent the object. That is, the model includes information about or derived from both the object and the other portions of the image included in the sample region because the model is derived from samples (e.g., pixel values) within the sample region. The model, therefore, represents both the portion of the object included in the sample region and the other portions of the image include in the sample region, which impairs the accuracy of the model as a representation of the object.

Additionally, a model generated from samples taken from one portion of an object within an image may not accurately represent the object when the object is visually spatially diverse. In other words, if the visual appearance of the object varies across the object (i.e., one segment of the object looks different than another segment of the object), a model generated from a sample region that includes one portion of the object, but not other portions of the object with visual appearances that differ from the portion of the object included in the sample region, may not accurately represent the entire object.

These limitations can cause such image segmentation systems to be overly inclusive (e.g., identify portions of the image that do not include parts of a particular object as including parts of the object) or overly exclusive (e.g., fail to identify portions of the image that are parts of the object). As a result, users often refine the segmentation performed by such image segmentation systems by manually adjusting which portions of the image are identified as including particular objects.

Moreover, image segmentation systems that rely on user input to select sample regions of an object within an image are unable to perform image segmentation independent of user input. Such image segmentation systems can be particularly problematic when implemented as network services (e.g., applications that are accessed via communications links such as the Internet), because such image segmentation systems require a user interface such as a graphical user interface (GUI) via with a user can identify or select a sample region of an image. Often, such image segmentation systems can appear slow or unresponsive to users when a GUI is provided for user input such as selection of a sample region due to latencies, throughput, and other limitations of communications links.

Implementations discussed herein identify objects within images using discriminative classifiers. For example, implementations discussed herein select sample regions of an image independent of user input. Such sample regions include foreground sample regions (i.e., sample regions that are targeted to or intended to include a portion of a particular object) and background sample regions (i.e., sample regions that are targeted to or are intended to include portions of an image that do not include a particular object). Additionally, the sample regions are associated with particular segments of an object within an image. Accordingly, the discriminative classifiers are also associated with, or tuned to, those segments. Thus, such implementations can identify segments of the object with enhanced accuracy when compared to other methodologies. The sample regions are then used to generate discriminative classifiers to identify an object against a background within the image without generating a model that represents the object. In some implementations, the object is a person (or human being), and a discriminative classifier is generated for each of a variety of segments of the person such as a hair segment, a pant segment, and a shirt segment.

As used herein, a functionality or operation is or is performed “independent of user input” if user input does not provide arguments, parameters, or other data to that functionality or operation. For example, a functionality or operation is performed independent of user input if the functionality or operation is invoked, initiated, or started by user input, but the user input does not provide data used as an operand within the functionality or operation. As another example, a functionality or operation is performed independent of user input if the functionality or operation is selected or specified by user input, but the user input does not provide data used as an operand within the functionality or operation.

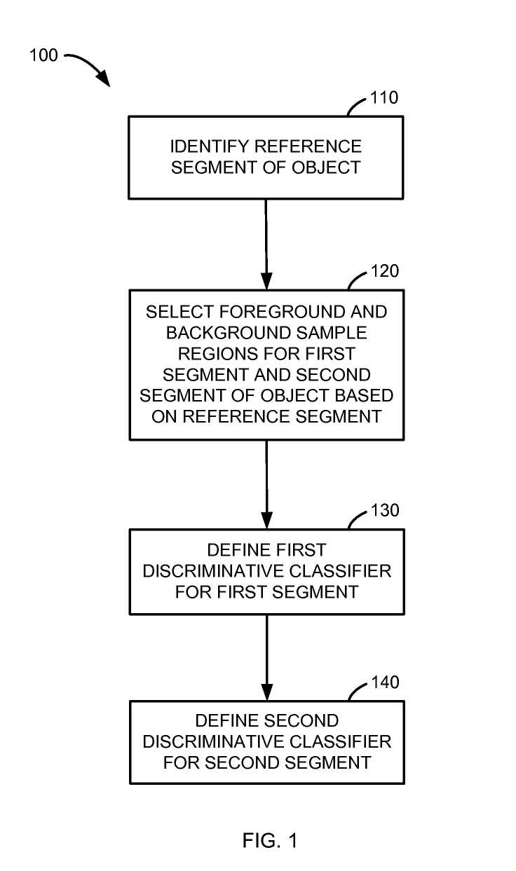

FIG. 1 is a flowchart of an image segmentation process, according to an implementation. As illustrated in FIG. 1, a reference segment of an object within an image is identified at block 110. An object can be any visual representation (or depiction) within an image. For example, an object can be a person, a plant such as a tree or a flower, a reflection, a landscape, an animal, or something else represented visually within an image.

Objects often include multiple segments. A segment is a portion or part of an object. For some objects, one segment of the object is visually distinct from other segments of the object. For example, a person depicted within an image can include a face segment, a hair segment, a shirt segment, and a pant segment, each of which is visually distinct from the other segments. As another example, a flower can have a stem segment, one or more leaf segments, and a corolla segment. Moreover some segments can include other segments. As an example, a corolla segment of a flower can include one or more petal segments.

A reference segment is a segment of an object that is used as a reference to identify other segments of the object. As such, reference segments can typically be identified with confidence. Said differently, a reference segment can be identified within an image from other portions of the image with a low error rate. Often, reference segments are visually distinctive or have visual properties that can be identified from other portions of an image. As examples, the face of a person, the corolla of a flower, and the license plate of an automobile can be reference segments.

As discussed above, the reference segment can be identified at block 110 independent of user input. For example, a user of an image segmentation system implementing process 100 can provide an image (e.g., a file including image data encoded according to any of a variety of such as a JPEG format, a GIF format, a bitmap format, or a PNG format) to the image segmentation system via a communications link. In response to receiving the image, the image segmentation system can analyze the image for reference segments. As a specific example, the image segmentation system can analyze the image to identify any of a group of segments as reference segments. More specifically, with reference to the examples above, the image segmentation system can analyze the image to identify a face of a person, a corolla of a flower, or a license plate of an automobile as a reference segment. In other words, the image segmentation system can apply various image processing techniques or processes such as template comparison, edge or other feature detection, or Hamming distance analysis to the image to identify the reference segment.

In some implementations, the image processing techniques or processes are directed to or tuned to identify reference segments of a particular type or class or of any from a group of types or classes of reference segments. In some implementations, the user can indicate to the image segmentation system for which class or type of reference segment the image should be analyzed. For example, the image segmentation system can provide an interface via which the user can indicate (e.g., select a checkbox or radio button) that the picture includes people, and the image segmentation system can identify a face of a person as the reference segment independent of user input. That is, user input identifies the type of reference segment (here, a face) for which the image segmentation system should analyze the image, but the user input does not include data such as a location, position, or area within the image that is used to identify the reference segment.

A foreground sample region and a background sample region for a first segment of the object of which the reference segment is a part is then selected (or identified or determined) at block 120 independent of user input. For example, the reference segment can be used at block 120 to identify a foreground sample region and a background sample region for a first segment of the object of which the reference segment is a part. Additionally, a foreground sample region and a background sample region for a second segment of the object are identified at block 120. Similar to the foreground sample region and a background sample region for the first segment, the foreground sample region and a background sample region for the second segment can be selected independent of user input.

Foreground and background sample regions can be (or be said to be) associated with particular segments of an object within an image. That is, the foreground and background sample regions can be positioned, sized, and/or oriented within the image (or portions of the image at particular positions and with particular sizes and/or orientations can be selected from the image), to be located within the image relative to the associated segments. As discussed in more detail herein, a discriminative classifier for each segment is generated from the foreground sample region and the background sample region associated with that segment. Accordingly, the discriminative classifier with a particular segment can be used to identify that segment with enhanced accuracy.

As illustrated in FIG. 1, the image segmentation system implementing process 100 selects foreground sample region and the background sample region for the first segment based on the reference segment identified at block 110. Said differently, the image segmentation system implementing process 100 defines the foreground sample region and the background sample region for the first segment relative to the reference segment. That is, the locations or positions of the foreground sample region and the background sample region of the first segment within the image depend on the reference segment. For example, a size of the reference segment, a location (or position) of the reference segment, an orientation of the reference segment, some other attribute or property of the reference segment, or a combination thereof can affect the locations of the foreground sample region and the background sample region of the first segment.

Furthermore, the locations of the foreground sample region and the background sample region of the first segment can depend on a physical property or attribute of the object. For example, a physical relationship can exist between the reference segment and the first segment, and the locations of the foreground sample region and the background sample region of the first segment can depend on that relationship.

As a more specific example, the reference segment can be a face of a person, and the first segment can be an upper-body or shirt segment of the person. A length of the face (e.g., a measure of the distance between the mouth and eyes) can be defined, and the foreground sample region for the shirt segment (i.e., the first segment) can be placed approximately three lengths of the face vertically below the top of the face (i.e., the reference segment). That is, a physical attribute (here, a relationship) between the size of the face and the location of the shirt segment can be used to determine where in an image to place or from where in an image to select the foreground sample region for the shirt segment. In some implementations, the foreground sample region for the shirt segment can be offset horizontally from the center of the face if the face is oriented to the left or right of the image. For example, if the face is oriented toward the left of the image, the foreground sample region for the shirt segment can be offset an absolute distance or a distance proportional to the orientation of the face to the left. Moreover, in some implementations, a size of the foreground sample region for the shirt segment can vary based on a size of the reference segment, a location of the reference segment, an orientation of the reference segment, some other attribute or property of the reference segment, or a combination thereof.

The background sample region for the first segment can also be selected based on the reference segment. For example, similar to the foreground sample region for the shirt segment, the background sample region for the shirt segment can be positioned relative to a size of the foreground sample region for the shirt segment can vary based on a physical attribute of the object (here, a person), a size of the reference segment, a location of the reference segment, an orientation of the reference segment, some other attribute or property of the reference segment, or a combination thereof. Although some portions of an image other than an object may be included in foreground sample regions and some portions of an object may be included in background sample regions, as discussed above, foreground sample regions are placed or selected to primarily include one or more portions of an object, and background sample regions are placed or selected to primarily include portions of an image other than the object. Moreover, in some implementations, a background sample region can partially overlap with a foreground sample region.

Accordingly, the background sample region for the first segment can be offset vertically and/or horizontally from the reference segment and/or foreground sample region for the first segment. Said differently, the location and/or size of the background sample region for the first segment can be determined solely based on the reference segment, or based on the reference segment and the foreground sample region for the first segment. Although the background sample region for the first segment may be determined based on the foreground sample region for the first segment, the background sample region for the first segment can be said to be based on the reference segment because the foreground sample region for the first segment is based on the reference segment.

As a more specific example, the location of the background sample region for the first segment can be determined as a vertical offset and a horizontal offset from a location and an orientation of the reference segment; and the size of the background sample region for the first segment can be determined from the size of the reference segment. As another specific example, the location of the background sample region for the first segment can be determined as a vertical offset and a horizontal offset from a location of the foreground sample region of the first segment; and the size of the background sample region for the first segment can be determined from the size of the reference segment.

As another example, the foreground sample region can be described by (X, Y), where x1<x<x2 and y1<y<y2. That is, the image can be described in a Cartesian coordinate system where X includes a number of x-coordinates in one dimension (the x dimension) between points x1 and x2, and Y includes a number of y-coordinates in another dimension (the y dimension) between points y1 and y2. The background sample region (or a group of background sample regions) can be selected by identifying the background of the image for the segment as follows. The foreground sample region can be extended by m in the x dimension and n in the y dimension to (X′, Y′), where x1−m<X′<x2+m and y1−n<Y′<y2+n, and the background of the image can be defined by (X″, Y″), where X″<x1−m∥X″>x2+m and Y″<y1−n∥Y″>y2+n. One or more background sample regions can then be selected from the background, (X″, Y″), of the image for the segment. In some implementations, m and n are equal.

In the example illustrated in FIG. 1, the foreground sample region and the background sample region for the second segment are also selected based on the reference segment. Accordingly, the foreground sample region and the background sample region for the second segment can be selected as described above related to selecting the foreground sample region and the background sample region for the first segment. In other implementations, the foreground sample region and the background sample region for the second segment can be selected using other methodologies. For example, the foreground sample region and the background sample region for the second segment can be selected based on the foreground sample region and/or the background sample region for the first segment. Thus, the foreground sample region and/or the background sample region for the first segment can be used as a reference to select the foreground sample region and the background sample region for the second segment. More specifically, in this example, the foreground sample region and the background sample region for the second segment can be selected relative to a size, a location, an orientation, some other attribute or property, or a combination thereof for the foreground sample region and/or the background sample region for the first segment.

After the foreground sample region and the background sample region for the first segment and the second segment are selected at block 120, discriminative classifiers are defined for the first segment at block 130 and the second segment at block 140. In other words, using sample such as pixel values within the sample regions, discriminative classifiers for or associated with each of the first segment and the second segment are generated. As discussed above, because a discriminative classifier for each segment is generated from the foreground sample region and the background sample region associated with that segment, that discriminative classifier can be said to be tuned to that segment (or the specific visual characteristics or traits of that segment). Accordingly, such discriminative classifiers can be used to identify segments with enhanced accuracy.

A discriminative classifier is a framework (e.g., data and operations for that data) to distinguish between two or more classes or classifications. In contrast with generative models, a discriminative classifier does not define a description or approximation of members of the classes the discriminative classifier classifies. For example, generative models can define a class in terms of a probabilistic or statistical distribution. Such models can be said to be generative models because the model can be used to generate a sample that is a member of the class modeled by a particular model. A discriminative classifier, rather, determines to which class a sample (or input value or collection of values) belongs by modeling the differences between/among the classes. Said differently, a model defines (or attempt to define) what a class is, discriminative classifier describes differences between two or more classes.

As examples of discriminative classifiers, support vector machines, conditional random fields, and some neural networks are discriminative classifiers. As another example, random forests (or random decision forests) are discriminative classifiers. Once trained for two or more classes (e.g., groups of data sets), such discriminative classifiers can accept a descriptor of a sample, and output an indication of to which class the sample belongs.

As a specific example of blocks 130 and 140, samples of the object and other portions of the image (i.e., the background of the image) can be accessed from the foreground sample region and the background sample region for the first segment, respectively, for the first segment. The samples can be, for example, pixel values in a color space such as RGB, CYMK, or YCbCr. Additionally, information such as texture information or gradient information can be generated from the samples, and can be included with the pixel values in a descriptor for each sample. That is, a descriptor including a color component, a texture component, and a gradient component can be defined for each sample within the foreground sample region and the background sample region for the first segment.

The descriptors for samples in the foreground sample region and the descriptors for samples in the background sample region for the first segment can be used as background data to define (e.g., train) at block 130 a discriminative classifier for the first segment that classifies other descriptors defined from sample values (e.g., pixel values) within the image as belonging to the foreground (here, the first segment of object to which the reference segment belongs) or the background (i.e., everything in the image other than the first segment of the object). The same methodology can be applied for the samples in the foreground sample region and the descriptors for samples in the background sample region for the second segment at block 140 to define the discriminative classifier for the second segment that classifies other descriptors defined from sample values (e.g., pixel values) within the image as belonging to the foreground (here, the second segment of object to which the reference segment belongs) or the background (here, everything in the image other than the second segment of the object).

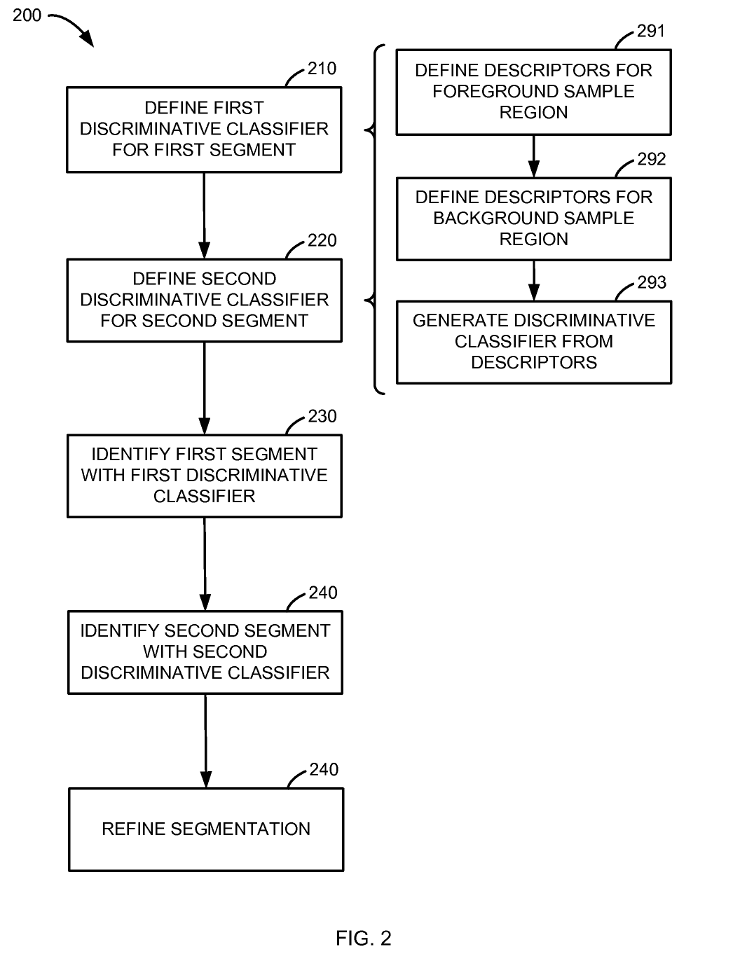

In some implementations, process 100 can be combined with other processes. For example, FIG. 2 is a flowchart of an image segmentation process, according to another implementation. Blocks 210 and 220 illustrated in FIG. 2 are similar to blocks 130 and 140 illustrated in FIG. 1.

At block 210, a first discriminative classifier is defined for a first segment of an object within an image, and a second discriminative classifier is defined for a second segment of an object within an image at block 220. As shown in the example illustrated in FIG. 2, blocks 291, 292, and 293 can be executed or processed for each of block 210 and 220. That is, blocks 291, 292, and 293 can be executed or processed to define a discriminative classifier is defined for a first segment at block 210 and a discriminative classifier is defined for a second segment at block 220.

Descriptors are defined or derived from the samples within a foreground sample region (e.g., either for the first segment or the second segment) at block 291. A descriptor is a data set that describes a sample. For example, as discussed above, a sample can be a pixel value, and a descriptor for that pixel value can include one or more color components, texture components, gradient components, and/or other components determined from that pixel value and/or neighboring pixel values. That is, a descriptor can include information different from and/or in addition to raw sample values such as information derived or synthesized from the sample described or represented by that descriptor and other samples in some proximity to that sample. Said differently, a descriptor for a sample can include more dimensions or have a higher order (i.e., a number of dimensions) than the dimensions or order of the sample.

Some dimensions of a descriptor can include texture information (e.g., variations in color or texture within a portion of an image). As examples, for each sample, a local binary patterns (LBP) histogram can be generated using a sample window such as a 7×7 sample (e.g., pixel) window, a 9×9 sample window, or a 5×5 sample window around that sample. In some implementations, the LBP histogram can be quantized into a number of bins and the number of values in each bin can be included within the descriptor. As a specific example, the LBP histogram can be quantized into four bins (e.g., one bin each for values between 0 and 63, between 64 and 127, between 128 and 191, and between 192 and 255), and the number of values in each of the four bins can be included within the descriptor. Such a histogram has four dimensions—one for each bin. Thus, in this example, the texture component of a descriptor is four-dimensional. In other implementations, a texture component of a descriptor can be defined using other methodologies and/or can include more or fewer dimensions.

Moreover, some dimensions of a descriptor can include gradient information (e.g., variations in color or intensity of an image along a particular direction or vector). As an example, for each sample, a histogram of oriented gradients (HOG) can be generated using a sample region such as a 7×7 sample region, a 9×9 sample region, or a 5×5 sample region around that sample. In some implementations, the HOG can be quantized into a number of bins, and the number of values in each bin can be included within the descriptor. As a specific example, the HOG can be quantized into four bins (e.g., one bin each for values between 0 and 89 degrees, between 90 and 179 degrees, between 180 and 269 degrees, and between 270 and 359 degrees), and the number of values in each of the four bin can be included within the descriptor. Thus, in this example, the gradient component of a descriptor is four-dimensional. In other implementations, a gradient component of a descriptor can be defined using other methodologies and/or can include more or fewer dimensions.

As a specific example, each sample (e.g., pixel value) within a sample region can include three values between 0 and 255 for each component (i.e., red, green, and blue) of an RGB color space. A descriptor for each sample can include the three color space values for that sample (e.g., a three-dimensional color component), four LBP texture values (e.g., a four-dimensional texture component as discussed above), and four HPG values (e.g., a four-dimensional gradient component as discussed above). Thus, each sample has 3 dimensions (i.e., an order of 3), and the descriptor for each sample has 11 dimensions (i.e., an order of 11).

Descriptors are defined or derived from the samples within a background sample region (e.g., either for the first segment or the second segment) at block 292 similarly as at block 291. A discriminative classifier based on the descriptors for the foreground sample region and the descriptors for the background sample region is then generated (or defined) at block 293. For example, as discussed above, the discriminative classifier for a segment can be defined by training the discriminative classifier (e.g., a random forest) using the descriptors for the foreground sample region and the descriptors for the background sample region. That is, the descriptors for the foreground sample region and the descriptors for the background sample region are provided to a framework representing the discriminative classifier for a segment to train the discriminative classifier based on the data (e.g., the samples and information derived or synthesized from the samples) within the descriptors defined at block 291 and 292.

After the first and second discriminative classifiers are defined at block 210 and 220, the first segment (or at least a portion thereof) and the second segment (or at least a portion thereof) are identified at blocks 230 and 240 using the first discriminative classifier and the second discriminative classifier, respectively. In other words, pixel values (or descriptors derived from those pixel values) from the image are provided to the first discriminative classifier to determine whether those pixel values are part of the first segment, and pixel values (or descriptors derived from those pixel values) from the image are provided to the second discriminative classifier to determine whether those pixel values are part of the second segment.

In some implementations, descriptors for each pixel value of the image are provided to the first discriminative classifier, and are marked, flagged, or annotated as part of the first segment (or in the foreground) or not part of the first segment (or in the background) based on output values from the first discriminative classifier. Such descriptors can be generated using the same or similar methodologies discussed above in relation to blocks 291 and 292. In some implementations, descriptors for each pixel value in the image are provided to the first and second discriminative classifiers. In other implementations, only descriptors for pixel values within some proximity of the foreground and background sample regions of the first segment are provided to the first discriminative classifier, and only descriptors for pixel values within some proximity of the foreground and background sample regions of the second segment are provided to the second discriminative classifier. In other words, in some implementations, only portions of the image local to the sample regions for a segment are analyzed by the discriminative classifier for that segment.

A description of the first segment can then be defined based on the pixel values that are determined to be part of or included within the first segment. Similarly, a description of the second segment can be defined based on the pixel values that are determined to be part of or included within the second segment. The descriptions of the first segment and second segment can be represented in a variety of forms or formats. For example, a descriptor can be a binary bit map or mask with an element (e.g., bit) for each pixel value in the image. If the element has a true value (e.g., a value of 1), the pixel value that corresponds to that element is included in the segment represented by that descriptor. Similarly, if the element has a false value (e.g., a value of 0), the pixel value that corresponds to that element is not included in the segment represented by that descriptor. In other implementations, a descriptor of a segment can include a list of vertices of one or more polygons that define a perimeter of that segment, a definition of a shape or shapes that define a perimeter of that segment, or a list of coordinates (e.g., Cartesian coordinates relative to an origin of the image) of pixel values that are included in the segment represented by that descriptor.

In some implementations, the first and second discriminative classifiers may output false negatives (e.g., determine that some pixel values that are included in the first or second, respectively, segment are not included in that segment) and false positives (e.g., determine that some pixel values that are not included in the first or second, respectively, segment are included in that segment). Thus, the descriptors of the first and second segments may have errors or defects (e.g., include pixel values that are not included in a particular segment or not include pixel values that are included in a particular segment) or not be entirely accurate.

The segmentation is then refined at block 250. For example, the description of the first segment and the description of the second segment can be combined to define a description of the object. The description of the object can be provided to a segmentation refinement engine to refine the identification of the object (or the first and second segments). For example, some segmentations methodologies such as graph cuts can produce highly refined segmentation in localized portions of an image if provided with an accurate description of the object to be segmented. Because the description of the object describes much of the object, this description can be provided to the segmentation refinement engine as the description of the object to be segmented, and the segmentation refinement engine can refine the identification of pixel values included in the object (e.g., in the first segment and second segment).

Processes 100 and 200 illustrated in FIGS. 1 and 2 are example implementations. In some implementations, these can vary from that illustrated in FIGS. 1 and 2. For example, in some implementations, more than two segments can be analyzed by an image segmentation system implementing process 100 or process 200. As a more specific example, sample regions and discriminative classifiers can be defined for three or more segments. As another example, some steps such as those illustrated at blocks 130 and 140, blocks 210 and 220, or blocks 230 and 240 can be performed in parallel or concurrently one with another.

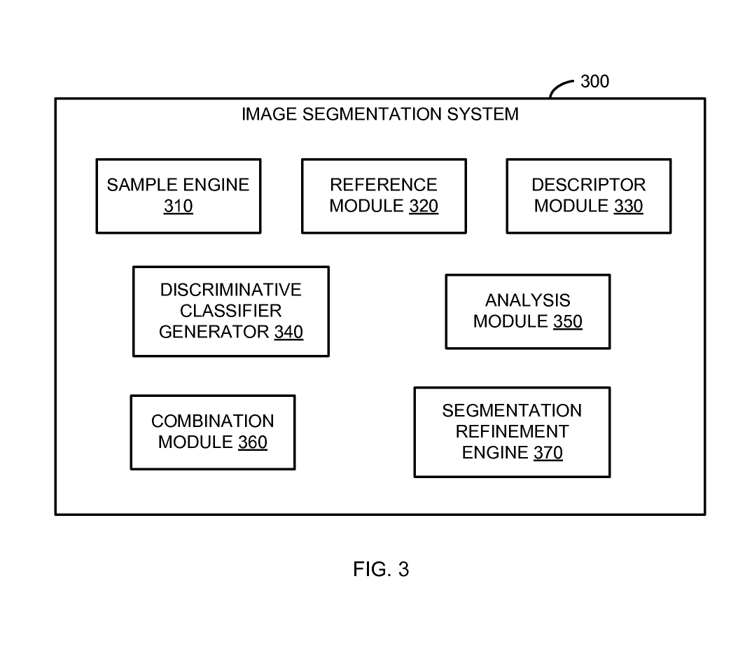

FIG. 3 is a schematic block diagram of an image segmentation system, according to an implementation. Image segmentation system 300 illustrated in FIG. 3 includes sample engine 310, reference module 320, descriptor module 330, discriminative classifier module 340, analysis module 350, combination module 360, and segmentation refinement engine 370. Sample engine 310, reference module 320, descriptor module 330, discriminative classifier module 340, analysis module 350, combination module 360, and segmentation refinement engine 370 are modules (i.e., combinations of hardware and software), and in some implementations image segmentation system 300 includes fewer or additional modules than illustrated in FIG. 3.

Furthermore, although various modules (i.e., combinations of hardware and software) are illustrated and discussed in relation to FIG. 3 and other example implementations, other combinations or sub-combinations of modules can be included within other implementations. Said differently, although the modules illustrated in FIG. 3 and discussed in other example implementations perform specific functionalities in the examples discussed herein, these and other functionalities can be accomplished, implemented, or realized at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

Sample engine 310 selects sample regions (i.e., foreground sample regions and background sample regions) for segments of an object within an image. For example, sample engine 310 can select sample regions based on physical attributes of an object (or a class of objects) and/or attributes of a reference segment. As discussed above, sample engine 310 can use a reference segment and/or such physical properties or attributes to select sample regions independent of user input. Additionally, sample engine 310 provides a description of sample regions to descriptor module 330.

Reference module 320 identifies a reference segment of an object within a image. For example, reference module 320 can implement various image processing methodologies such as edge detection, character recognition, skin tone or texture recognition, facial feature recognition, and/or template matching to identify a reference segment. Moreover, reference module 320 can provide a description of the reference segment to sample engine 310, and sample engine 310 can use attributes of a reference segment to select sample regions.

Descriptor module 330 defines descriptors for sample regions. For example, as discussed above in relation to blocks 291 and 292 of FIG. 2, descriptor module 330 can generate descriptors for samples in the sample regions selected at sample engine 310. That is, for example, sample engine 310 can provide a description of sample regions to descriptor module 330, and descriptor module 330 can access samples (e.g., pixel values) of the image within those sample regions. Descriptor module 330 can then define descriptors from those samples.

Discriminative classifier generator 340 receives the descriptors generated at descriptor module 330, and defines (or generates) a discriminative classifier for segments of the object within the image using descriptors for each segment. In some implementations, discriminative classifier generator 340 can generate and train a random forest for each segment using the descriptors defined using the samples from the foreground and the background sample regions. In other implementations, other frameworks such as support vector machines can be generated and/or trained for each segment at discriminative classifier generator 340.

Analysis module 350 analyzes the image using discriminative classifiers defined at discriminative classifier generator 340. In other words, analysis module 350 applies portions of the image (e.g., pixel values) to the discriminative classifiers to determine which portions of the image are included in the segments associated with those discriminative classifiers. Said differently, analysis module 350 applies the discriminative classifiers to portions of the image to identify the segments (or portions thereof) associated with those discriminative classifiers.

In some implementations, analysis module 350 identifies other segments of an object using methodologies other than discriminative classifiers. For example, if the object is a person and a face segment is the reference segment for the object, analysis module can generate a model such as a Gaussian mixture model (GMM) (or use a GMM generated at a different module) for skin tones or textures. The model can then be applied to the image to identify skin segments of the person (e.g., portions of the image that include parts of the person with exposed skin).

As another example, subtraction methodologies such as background methodologies can be used to identify other segments of an object. As an example with a person as the object and a lower-leg segment (e.g., below the knees of the person), lower-leg segment can be identified by background subtraction. More specifically for this example, a background region for the lower-leg segment can be defined by masking skin segments below a pant (here, knee-length pants or shorts) segment. In some implementations, the skin segments can be dilated and the skin segments and a central region of the image below the pant segment can be masked (or ignored). The unmasked or remaining portions or regions of the image in some proximity to the masked dilated skin segments and masked central region can then be used to generate a model. That is, for example, pixel values in those remaining portions can be used to train a GMM for the background of the lower-leg segment. The model can then be applied to the image to subtract the lower-leg segment from the background. For example, the portions of the image below the pant segment that match or satisfy the GMM for the background can be subtracted from the image (or marked or flagged as not part of the lower-leg segment).

Additionally, analysis module 350 can generate descriptors for the segments identified at analysis module 350, which can be provided to segmentation refinement engine 370 or to combination module 360, at which the descriptions for the segments are combined or joined to define a description of the object that is provided to segmentation engine 370. As discussed above, the segments identified at analysis module 350 and described by the descriptors can include errors or defects (e.g., false positive and/or false negative data).

Segmentation refinement engine 370 further refines the segmentation to more accurately extract the object. For example, segmentation refinement engine 370 can implement sensitive graph cut methodologies to segment areas of the image in close proximity to the object. More specifically, for example, segmentation refinement engine 370 can receive the descriptors of the segments identified at analysis module 350 (or a descriptor of the object defined from those descriptors) as input, and define a portion of the image adjacent to (or about) those segments as an unknown area. For example, analysis module 350 can define a description of a 10-pixel-wide periphery around the segments identified at analysis module 350, and can provide that description to segmentation refinement engine 370. Segmentation refinement engine 370 can then apply, for example, a graph cut process to the description of the segments and the description of the periphery to determine which pixels in the periphery and at the edges of the identified segments should be included in the segments. Segmentation refinement engine 370 can then output a refined description of the object. This description can be used, for example, to copy the object from the image (e.g., copy the pixel values of the object); and that copy of the image can be stored separate from the image, inserted into another image, or otherwise manipulate the image separate from the object.

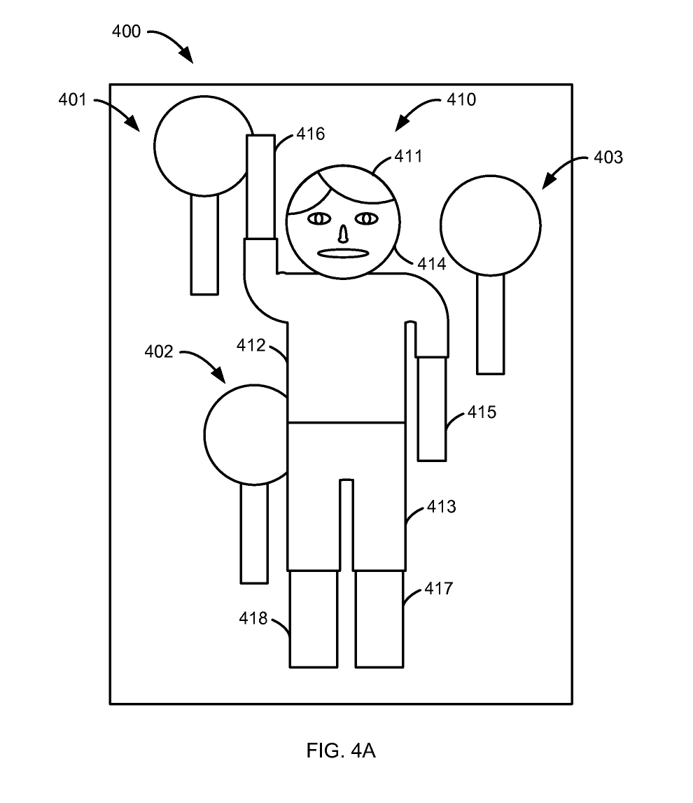

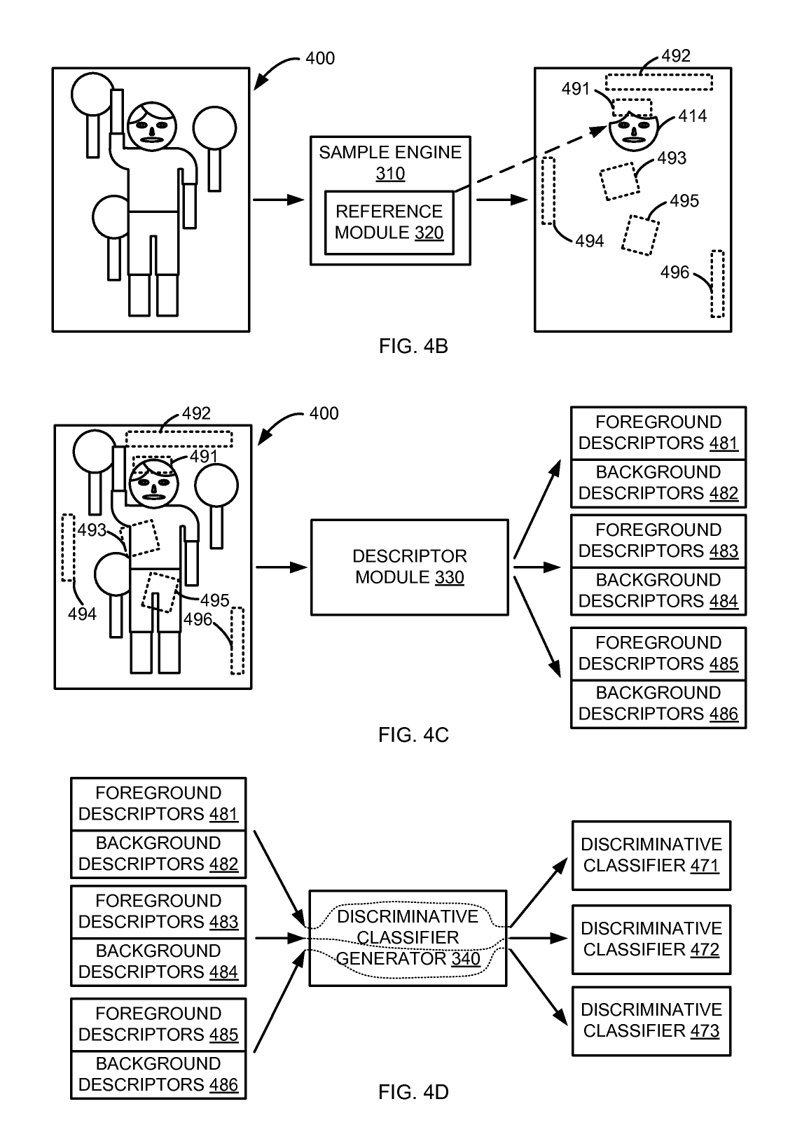

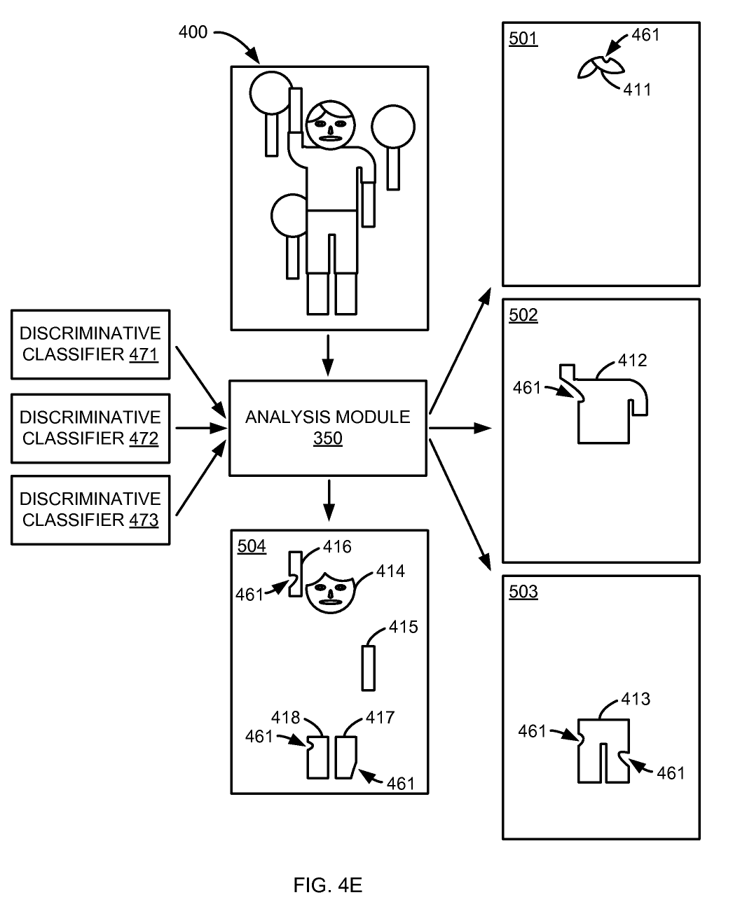

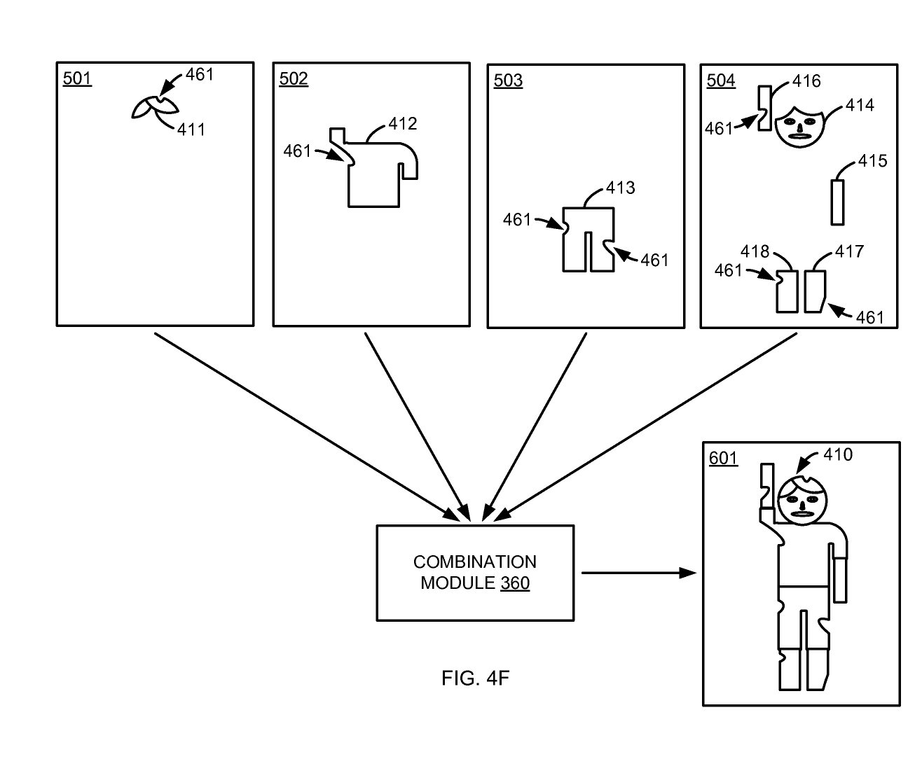

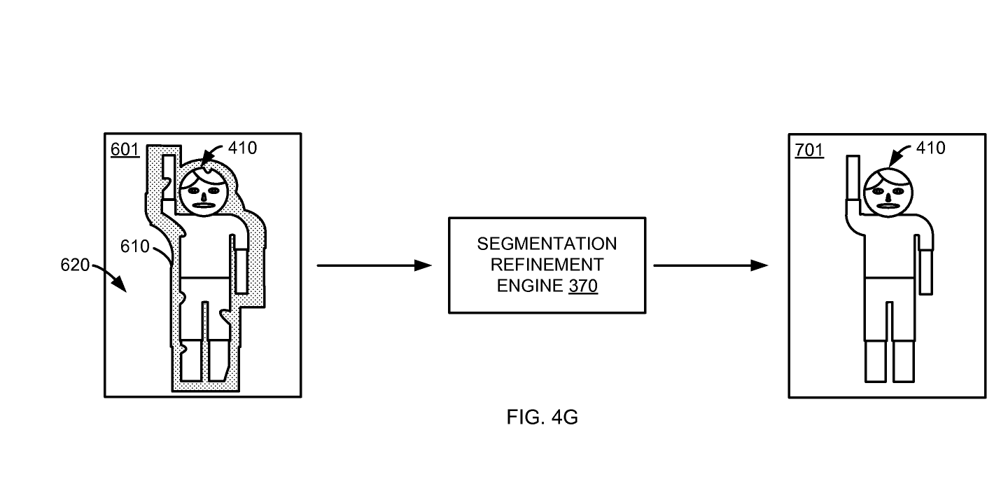

As a specific example of the operation of an image segmentation system, FIGS. 4A-4G illustrate image segmentation within an image segmentation, according to an implementation. Image 400 illustrated in FIG. 4A includes objects 401, 402, 403, and 410. Object 410 is a person (or human being) which includes hair segment 411, shirt (or upper-body) segment 412, pant (or lower-body) segment 413, face segment 414, arm segments 415 and 416, and leg segments 417 and 418.

As illustrated in FIG. 4B, image 400 is provided to sample engine 310. In the example illustrated in FIG. 4B, sample engine 310 includes reference module 320. For example, reference module 320 and sample engine 310 can be configured to identify face segments as reference segments and select foreground and background sample regions for each of a hair segment, a shirt segment, and a pant segment. Accordingly, reference module 320 identifies face segment 414 as a reference segment for object 410. Sample engine 310 selects, based on face segment 414 (here, the reference segment) sample regions 491 and 492 as foreground and background sample regions for hair segment 411, sample regions 493 and 494 as foreground and background sample regions for shirt segment 412, and sample regions 495 and 496 as foreground and background sample regions for pant segment 495 and 496. As discussed above, sample regions 491-496 are positioned based on face segment 414. Thus, for example, if face segment 414 was a different size, at a different location or position within image 400, or oriented differently (e.g., turned toward the left or upside down), sample engine 310 could select different portions of image 400 as sample regions 491-496.

As illustrated in FIG. 4C, foreground sample region 493 includes a portion of image 400 that does not include object 410, and foreground sample region 495 includes a portion of image 400 that does not include object 410. Image 400 and sample regions 491-496 (or descriptions thereof) are provided, as illustrated in FIG. 4C, to descriptor module 330, which generates foreground descriptors 481 and background descriptors 482 for hair segment 411, foreground descriptors 483 and background descriptors 484 for shirt segment 412, and foreground descriptors 485 and background descriptors 486 for pant segment 413. In other words, a group of descriptors (e.g., one for each sample) is generated each region of sample regions 491-496.

Foreground descriptors 481, background descriptors 482, foreground descriptors 483, background descriptors 484, foreground descriptors 485, and background descriptors 486 are then provided to discriminative classifier generator 340 as illustrated in FIG. 4D to generate discriminative classifiers 471, 472, and 473. As illustrated in FIG. 4D, discriminative classifier 471 is derived from or based on foreground descriptors 481 and background descriptors 482, discriminative classifier 472 is derived from or based on foreground descriptors 483 and background descriptors 484, and discriminative classifier 473 is derived from or based on foreground descriptors 485 and background descriptors 486. Said differently, discriminative classifier 471 is associated with or for hair segment 411, discriminative classifier 472 is associated with or for shirt segment 412, and discriminative classifier 473 is associated with or for pant segment 413.

Discriminative classifiers 471, 472, and 473 and image 400 are then provided to analysis module 350 as illustrated in FIG. 4E. In some implementations, a description of face segment 414 and/or sample regions 491-496 are also provided to analysis module 350. Analysis module applies discriminative classifiers 471, 472, and 473 to image 400 to generate description 501 of hair segment 411, description 502 of shirt segment 412, and description 503 of shirt segment 503. For example, analysis module 350 can provide all the pixels of image 400 to each of discriminative classifiers 471, 472, and 473; and discriminative classifier 471 can identify the portions of image 400 included in description 501, discriminative classifier 472 can identify the portions of image 400 included in description 502, and discriminative classifier 473 can identify the portions of image 400 included in description 503. As another example, analysis module 350 can provide pixels in some proximity to foreground sample region 491 to discriminative classifier 471 to identify hair segment 411, pixels in some proximity to foreground sample region 493 to discriminative classifier 492 to identify shirt segment 412, and pixels in some proximity to foreground sample region 495 to discriminative classifier 473 to identify pant segment 413.

In some implementations, analysis module 350 also identifies arm segments 415 and 416 and/or leg segments 417 and 418, and defines description 504 of those segments. For example, a description of face segment 414 can be provided to analysis module 350, and analysis module can identify arm segments 415 and 416 and/or leg segments 417 and 418 based on face segment 414. As a more specific example, analysis module 350 can define a model of skin tone and/or texture of object 410 based on face segment 414, and can identify portions of image 400 that fit the model as arm segments 415 and 416 and/or leg segments 417 and 418 based on physical attributes of object 410. For example, analysis module 350 can be configured to identify objects that are persons, and can identify arm segments 415 and 416 and/or leg segments 417 and 418 based on a model derived from face segment 414 and anatomy or physiology of the human body.

As another example, analysis module 350 can define a discriminative classifier for face segment 414 using, for example, a foreground sample region that include face segment 414 can one or more of sample regions 491-496 and/or other sample regions as background sample regions. That discriminative classifier can then be applied to image 400 at analysis module 350 to identify arm segments 415 and 416 and/or leg segments 417 and 418.

As illustrated in FIGS. 4E and 4F, descriptions 501-504 include defects 461. That is, defects 461 are portions of image 400 that were not identified correctly by analysis module 350. In some implementations, and as illustrated in FIG. 4F, descriptions 501-504 are combined into description 601 of object 401 at combination module 360. In other implementations, descriptions 501-504 are input to segmentation refinement engine 370.

The image segmentation system defines a portion of image 400 adjacent to object 410 as an unknown region of image 400. This portion of image 400 is illustrated as region 610 in FIG. 4G. That is, description 601 of object 410 is represents object 410 to segmentation refinement engine 370, region 610 represents a portion of image 400 in which pixel values may or may not be part of object 410, and region 620 (i.e., the remaining portion of image 400) represents a portion of image 400 that does not include pixel values that are part of object 410. In implementations in which descriptions 501-504 are input to segmentation refinement engine 370, an unknown region adjacent to each of the segments described by descriptions 501-504 can be defined and also input to segmentation refinement engine 370.

Description 601 and descriptions of regions 610 and 620 can be provided to segmentation refinement engine 370 to generate description 701 of image 410. As illustrated in FIG. 4G, the defects 461 illustrated in FIG. 4E, FIG. 4F, and description 601 of FIG. 4G are not present in description 701. That is, segmentation refinement engine 370 identifies portions of region 610 that should be included in description 701 of object 410. In some implementations, segmentation refinement engine 370 identifies portions description 601 of object 410 that are not part of object 410. In other words, segmentation refinement engine 370 refines the separation of the foreground (here, description 601 of object 410) from the background of image 400.

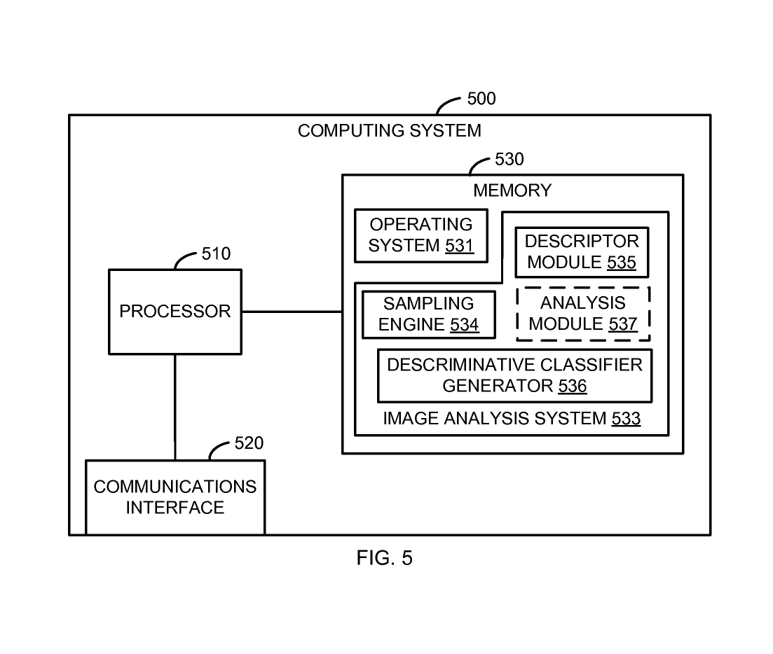

FIG. 5 is a schematic block diagram of an image segmentation system hosted at a computing system, according to an implementation. In the example illustrated in FIG. 5, computing system 500 includes processor 510, storage interface 520, and memory 530; and hosts operating system 531 and image segmentation system 533. Image segmentation system 533 includes a group of components including sampling engine 534, descriptor module 535, and discriminative classifier generator 536. In some implementations, image segmentation system 533 also includes analysis module 537.

Processor 510 is any combination of hardware and software that executes or interprets instructions, codes, or signals. For example, processor 510 can be a microprocessor, an application-specific integrated circuit (ASIC), a distributed processor such as a cluster or network of processors or computing systems, a multi-core or multi-processor processor, or a virtual or logical processor of a virtual machine.

Communications interface 520 is a module via which processor 510 can communicate with other processors or computing systems via a communications link. For example, communications interface 520 can include a network interface card and a communications protocol stack hosted at processor 510 (e.g., instructions or code stored at memory 530 and executed or interpreted at processor 510 to implement a network protocol) to communicate with clients to receive images. As specific examples, communications interface 520 can be a wired interface, a wireless interface, an Ethernet interface, a Fiber Channel interface, an InfiniBand interface, and IEEE 802.11 interface, or some other communications interface via which processor 510 can exchange signals or symbols representing data to communicate with other processors or computing systems.

Memory 530 is a processor-readable medium that stores instructions, codes, data, or other information. As used herein, a processor-readable medium is any medium that stores instructions, codes, data, or other information non-transitorily and is directly or indirectly accessible to a processor. Said differently, a processor-readable medium is a non-transitory medium at which a processor can access instructions, codes, data, or other information. For example, memory 530 can be a volatile random access memory (RAM), a persistent data store such as a hard disk drive or a solid-state drive, a compact disc (CD), a digital video disc (DVD), a Secure Digital™ (SD) card, a MultiMediaCard (MMC) card, a CompactFlash™ (CF) card, or a combination thereof or other memories. Said differently, memory 530 can represented multiple processor-readable media. In some implementations, memory 530 can be integrated with processor 510, separate from processor 510, or external to computing system 500.

Memory 530 includes instructions or codes that when executed at processor 510 implement operating system 531 and image segmentation system 533 (and the components or modules of image segmentation system 533). Said differently, image segmentation system 533, or the modules that define image segmentation system 533, is hosted at computing system 500.

In some implementations, computing system 500 can be a virtualized computing system. For example, computing system 500 can be hosted as a virtual machine at a computing server. Moreover, in some implementations, computing system 500 can be a virtualized computing appliance, and operating system 531 is a minimal or just-enough operating system to support (e.g., provide services such as a communications protocol stack and access to components of computing system 500 such as communications interface 520) image segmentation system 533.

Image segmentation system 533 can be accessed or installed at computing system 500 from a variety of memories or processor-readable media. For example, computing system 500 can access image segmentation system 533 at a remote processor-readable medium via communications interface 520. As a specific example, computing system 500 can be a thin client that accesses operating system 653131 and image segmentation system 533 during a boot sequence.

As another example, computing system 500 can include (not illustrated in FIG. 5) a processor-readable medium access device (e.g., CD, DVD, SD, MMC, or a CF drive or reader), and can access image segmentation system 533 at a processor-readable medium via that processor-readable medium access device. As a more specific example, the processor-readable medium access device can be a DVD drive at which a DVD including an installation package for image segmentation system 533 is accessible. The installation package can be executed or interpreted at processor 510 to install image segmentation system 533 at computing system 500 (e.g., at memory 530). Computing system 500 can then host or execute image segmentation system 533.

In some implementations, image segmentation system 533 can be accessed at or installed from multiple sources, locations, or resources. For example, some component of image segmentation system 533 can be installed via a communications link, and other components of image segmentation system 533 can be installed from a DVD.

In other implementations, image segmentation system 533 can be distributed across multiple computing systems. That is, some components of image segmentation system 533 can be hosted at one computing system and other components of image segmentation system 533 can be hosted at another computing system or computing systems. As a specific example, image segmentation system 533 can be hosted within a cluster of computing systems where each component of image segmentation system 533 is hosted at multiple computing systems, and no single computing system hosts each component of image segmentation system 533.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

As used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or at hardware and software hosted at hardware.

Additionally, as used herein, the singular forms “a,” “an,” and “the” include plural referents unless the context clearly dictates otherwise. Thus, for example, the term “module” is intended to mean one or more modules or a combination of modules. Moreover, the term “provide” as used herein includes push mechanism (e.g., sending data via a communications path or channel), pull mechanisms (e.g., delivering data in response to a request), and store mechanisms (e.g., storing data at a data store or service at which the data can be accessed). Furthermore, as used herein, the term “based on” includes based at least in part on. Thus, a feature that is described as based on some cause, stimulus, or data; can be based only on that cause, stimulus, or data; or based on that cause, stimulus, or data and on one or more other causes, stimuli, or data.

What is claimed is:

1. An image segmentation method, comprising:
defining a first discriminative classifier associated with a first segment of an object in an image based on a first foreground sample region of the image and a first background sample region of the image;
defining a second discriminative classifier associated with a second segment of the object based on a second foreground sample region of the image and a second background sample region of the image;
identifying at least a portion of the first segment using the first discriminative classifier; and
identifying at least a portion of the second segment using the second discriminative classifier.

2. The method of claim 1, further comprising:
identifying a reference segment of the object; and
selecting, independent of user input, the first foreground sample region based on at least one of a size of the reference segment, a location of the reference segment, an orientation of the reference segment, or a combination thereof.

3. The method of claim 1, further comprising:
identifying a reference segment of the object;
selecting, independent of user input, the first foreground sample region based on at least one of a size of the reference segment, a location of the reference segment, an orientation of the reference segment, or a combination thereof; and
selecting, independent of user input, the second foreground sample region based on at least one of the size of the reference segment, the location of the reference segment, the orientation of the reference segment, or a combination thereof.

4. The method of claim 1, wherein the first foreground sample region, the first background sample region, the second foreground sample region, and the second background sample region each include a plurality of samples, further comprising:
defining a first plurality of descriptors based on the first foreground sample region, an order of each descriptor in the first plurality of descriptors being greater than an order of each sample in the plurality of samples of the first foreground sample region;
defining a second plurality of descriptors based on the first background sample region, an order of each descriptor in the second plurality of descriptors being greater than an order of each sample in the plurality of samples of the first background sample region,
the first discriminative classifier defined based on the first plurality of descriptors and the second plurality of descriptors;
defining a third plurality of descriptors based on the second foreground sample region, an order of each descriptor in the third plurality of descriptors being greater than an order of each sample in the plurality of samples of the second foreground sample region;
defining a fourth plurality of descriptors based on the second background sample region, an order of each descriptor in the fourth plurality of descriptors being greater than an order of each sample in the plurality of samples of the second background sample region,
the second discriminative classifier defined based on the third plurality of descriptors and the fourth plurality of descriptors.

5. The method of claim 1, wherein:
the defining the first discriminative classifier includes deriving a first plurality of descriptors from the first foreground sample region and a second plurality of descriptors from the first background sample region, each descriptor in the first plurality of descriptors including a color component, a texture component, and a gradient component, each descriptor in the second plurality of descriptors including a color component, a texture component, and a gradient component; and
the defining the second discriminative classifier includes deriving a third plurality of descriptors from the second foreground sample region and a fourth plurality of descriptors from the second background sample region, each descriptor in the third plurality of descriptors including a color component, a texture component, and a gradient component, each descriptor in the fourth plurality of descriptors including a color component, a texture component, and a gradient component.

6. The method of claim 1, further comprising:
providing to a segmentation refinement engine a description of a first portion of the image including the at least a portion of the first segment and the at least a portion of the second segment and a description of a second portion of the image adjacent to the first portion of the image.

7. The method of claim 1, wherein at least a portion of the first background sample region is the same as at least a portion of the second background sample region.

8. The method of claim 1, wherein:
the object is a human being;
the first segment is a shirt segment; and
the second segment is a pant segment.

9. An image segmentation system, comprising:
a sample engine to select, independent of user input, a first foreground sample region of the image, a first background sample region of the image, a second foreground sample region of the image, and a second background sample region of the image;
a descriptor module to define a plurality of descriptors associated with the first foreground sample region, a plurality of descriptors associated with the first background sample region, a plurality of descriptors associated with the second foreground sample region, and a plurality of descriptors associated with the second background sample region;
a discriminative classifier generator to define a first discriminative classifier associated with a first segment of an object in the image and a second discriminative classifier associated with a second segment of the object,
the first discriminative classifier based on the plurality of descriptors associated with the first foreground sample region and the plurality of descriptors associated with the first background sample region,
the second discriminative classifier based on the plurality of descriptors associated with the second foreground sample region and the plurality of descriptors associated with the second background sample region.

10. The system of claim 9, further comprising:
an analysis module to apply the first discriminative classifier to a first portion of the image to identify at least a portion of the first segment of the object, and to apply the second discriminative classifier to a second portion of the image to identify at least a portion of the second segment of the object.

11. The system of claim 9, further comprising:
an analysis module to apply the first discriminative classifier to a first portion of the image to identify at least a portion of the first segment of the object, and to apply the second discriminative classifier to a second portion of the image to identify at least a portion of the second segment of the object; and
a combination module to define a description of the object based on the at least a portion of the first segment of the object and the at least a portion of the second segment of the object.

12. The system of claim 9, further comprising:
an analysis module to apply the first discriminative classifier to a first portion of the image to identify at least a portion of the first segment of the object, and to apply the second discriminative classifier to a second portion of the image to identify at least a portion of the second segment of the object;
a combination module to define a first description of the object based on the at least a portion of the first segment of the object and the at least a portion of the second segment of the object; and
a segmentation refinement engine to define a second description of the object based on the first description of the object and a description of a portion of the image adjacent to the object.

13. The system of claim 9, further comprising:
a reference module to identify a reference segment of the object, the sample engine configured to select the first foreground sample region based on at least one of a size of the reference segment, a location of the reference segment, an orientation of the reference segment, or a combination thereof.

14. The system of claim 9, further comprising:
a reference module to identify a reference segment of the object, the sample engine configured to select the first foreground sample region based on a physical attribute of the object and at least one of a size of the reference segment, a location of the reference segment, an orientation of the reference segment, or a combination thereof.

15. The system of claim 9, wherein each descriptor defined at the descriptor module includes a color component, a texture component, and a gradient component.

16. A processor-readable medium, comprising code representing instructions that when executed at a processor cause the processor to:
identify a reference segment of an object within an image;
select, independent of user input, a first foreground sample region of the image and a first background sample region of the image, the first foreground sample region selected based on at least one of a size of the reference segment, a location of the reference segment, an orientation of the reference segment, or a combination thereof;
select, independent of user input, a second foreground sample region of the image and a second background sample region of the image;
define a first discriminative classifier based on the first foreground sample region and the first background sample region; and
define a second discriminative classifier based on the second foreground sample region and the second background sample region.

17. The processor-readable medium of claim 16, wherein the first foreground sample region and the first background sample region of the image are associated with a first segment of the object different from the reference segment and the second foreground sample region and the second background sample region of the image are associated with a second segment of the object different from the reference segment and the first segment, the processor-readable medium further comprising code representing instructions that when executed at the processor cause the processor to:
identify at least a portion of the first segment using the first discriminative classifier and at least a portion of the second segment using the second discriminative classifier.

18. The processor-readable medium of claim 16, wherein the first foreground sample region and the first background sample region of the image are associated with a first segment of the object different from the reference segment and the second foreground sample region and the second background sample region of the image are associated with a second segment of the object different from the reference segment and the first segment, the processor-readable medium further comprising code representing instructions that when executed at the processor cause the processor to:
identify at least a portion of the first segment using the first discriminative classifier and at least a portion of the second segment using the second discriminative classifier; and
generate a description of the object based on the at least a portion of the first segment and the at least a portion of the second segment.

19. The processor-readable medium of claim 16, wherein the second foreground sample region is selected based on a physical attribute of the object and at least one of a size of the reference segment, a location of the reference segment, an orientation of the reference segment, or a combination thereof.

20. The processor-readable medium of claim 16, wherein:
the first discriminative classifier includes a color dimension, a texture dimension, and a gradient dimension; and
the second discriminative classifier includes a color dimension, a texture dimension, and a gradient dimension.
